(19) United States
(12) Patent Application Publication
(10) Pub. No.: US 2022/0327385 A1
(43) Pub. Date: Oct. 13, 2022

(54) NETWORK TRAINING METHOD, ELECTRONIC DEVICE AND STORAGE MEDIUM

(71) Applicant: Beijing Sensetime Technology Development Co., Ltd., Beijing (CN)

(72) Inventors: Xingang PAN, Beijing (CN); Xiaohang ZHAN, Beijing (CN); Bo DAI, Beijing (CN); Dahua LIN, Beijing (CN); Ping LUO, Beijing (CN)

(21) Appl. No.: 17/853,816

(22) Filed: Jun. 29, 2022

Related U.S. Application Data
(63) Continuation of application No. PCT/CN2020/099953, filed on Jul. 2, 2020.

(30) Foreign Application Priority Data
Jan. 9, 2020 (CN) 202010023029.7

(51) Int. Cl. G06N 3/08; G06T 3/40; G06N 3/04

(52) U.S. Cl. CPC G06N 3/08; G06T 3/4046; G06N 3/0454

(57) ABSTRACT

The present disclosure relates to a network training method, an electronic device and a storage medium. The network training method includes the following steps. At least one implicit vector may be input into at least one pre-trained generative network to obtain a first generated image; the generative network may be obtained with a discriminative network through adversarial trainings with a plurality of natural images. A degradation process may be performed on the first generated image to obtain a first degraded image of the first generated image. The implicit vector and the generative network may be trained according to the first degraded image and a second degraded image of at least one target image; the trained generative network and the trained implicit vector may be used to generate at least one reconstructed image of the target image.

### CROSS-REFERENCE TO RELATED APPLICATION

This present application is a continuation of and claims priority under 35 U.S.C. § 120 to PCT Application. No. PCT/CN2020/099953, filed on Jul. 2, 2020, which claims priority of Chinese Patent Application No. 202010023029.7 filed on Jan. 9, 2020, and entitled “NETWORK TRAINING METHOD AND APPARATUS, IMAGE GENERATION METHOD AND APPARATUS”. All the above referenced priority documents are incorporated herein by reference.

### TECHNICAL FIELD

The present disclosure relates to the technical field of computers, and particularly to a network training method and apparatus, and an image generation method and apparatus.

### BACKGROUND

Among various image processing tasks for deep learning, designing or learning image priors is an important issue in the tasks of image restoration, image manipulation, etc. For example, the deep image prior indicates that a randomly-initialized convolutional neural network has low-level image priors, which can be used to achieve super-resolution, inpainting, etc.

### SUMMARY

The present disclosure provides technical solutions for network training and image generation.

In one aspect of the present disclosure, there is provided a network training method, comprising: inputting at least one implicit vector into at least one pre-trained generative network to obtain a first generated image, wherein the generative network being obtained with a discriminative network through adversarial trainings with a plurality of natural images; performing a degradation process on the first generated image to obtain a first degraded image of the first generated image; and training the implicit vector and the generative network according to the first degraded image and a second degraded image of at least one target image, wherein a trained generative network and a trained implicit vector are used to generate at least one reconstructed image of the target image.

In a possible implementation, training the implicit vector and the generative network according to the first degraded image and the second degraded image of the at least one target image includes: inputting the first degraded image and the second degraded image of the target image respectively into a pre-trained discriminative network for processing, to obtain a first discriminative feature of the first degraded image and a second discriminative feature of the second degraded image; and training the implicit vector and the generative network according to the first discriminative feature and the second discriminative feature.

In a possible implementation, the discriminative network includes multiple levels of discriminative network blocks, and inputting the first degraded image and the second degraded image of the target image respectively into the pre-trained discriminative network for processing to obtain the first discriminative feature of the first degraded image and the second discriminative feature of the second degraded image includes: inputting the first degraded image into the discriminative network for processing to obtain a plurality of first discriminative features outputted by the multiple levels of discriminative network blocks of the discriminative network; and inputting the second degraded image into the discriminative network for processing to obtain a plurality of second discriminative features outputted by the multiple levels of discriminative network blocks of the discriminative network.

In a possible implementation, training the implicit vector and the generative network according to the first discriminative feature and the second discriminative feature includes: determining a network loss of the generative network according to a distance between the first discriminative feature and the second discriminative feature; and training the implicit vector and the generative network according to the network loss of the generative network.

In a possible implementation, the generative network includes N levels of generative network blocks, and training the implicit vector and the generative network according to the network loss of the generative network includes: training first n levels of generative network blocks of the generative network according to the network loss of the generative network after an (n−1)th round of training, to obtain the generative network after an nth round of training, where 1≤n≤N and n and N are integers.

In a possible implementation, the method further comprises: inputting a plurality of initial implicit vectors into the pre-trained generative network to obtain a plurality of second generated images; and determining the implicit vector from the plurality of initial implicit vectors according to information on difference between the target image and the plurality of second generated images.

In a possible implementation, the method further comprises inputting the target image into a pre-trained coding network to output the implicit vector.

In a possible implementation, the method further comprises: inputting the trained implicit vector into the trained generative network to obtain the reconstructed image of the target image, wherein the reconstructed image includes a color image, and the second degraded image of the target image includes a gray level image; or the reconstructed image includes a complete image, and the second degraded image includes a deficient image; or a resolution of the reconstructed image is greater than a resolution of the second degraded image.

In one aspect of the present disclosure, there is provided an image generation method, comprising: performing a disturbance process on an implicit vector by random jittering information to obtain a disturbed implicit vector; and inputting a disturbed implicit vector into a generative network for processing to obtain a reconstructed image of a target image, wherein a position of an object in the reconstructed image being different from a position of the object in the target image, wherein the implicit vector and the generative network are obtained from training according to the above network training method.

In one aspect of the present disclosure, there is provided an image generation method, comprising: inputting an implicit vector and a category feature of a preset category into a generative network for processing to obtain a reconstructed image of a target image, wherein the generative network including a conditional generative network, a category of an object in the reconstructed image including the preset category, and a category of the object in the target image being different from the preset category, wherein the implicit vector and the generative network are obtained from training according to the above network training method.

In one aspect of the present disclosure, there is provided an image generation method, comprising: performing an interpolation process respectively on a first implicit vector, a second implicit vector, parameters of a first generative network and parameters of a second generative network, to obtain at least one interpolated implicit vector and parameters of at least one interpolated generative network, wherein the first generative network being configured to generate a first reconstructed image of a first target image according to the first implicit vector, the second generative network being configured to generate a second reconstructed image of a second target image according to the second implicit vector; and inputting each interpolated implicit vector respectively into a corresponding interpolated generative network to obtain at least one morphing image, wherein a posture of an object in the at least one morphing image being between a posture of the object in the first target image and a posture of the object in the second target image, wherein the first implicit vector, the first generative network, the second implicit vector and the second generative network are obtained from training according to the above network training method.

In one aspect of the present disclosure, there is provided a network training apparatus, comprising: a first generative module, configured to input at least one implicit vector into at least one pre-trained generative network to obtain a first generated image, wherein the generative network being obtained with a discriminative network through adversarial trainings with a plurality of natural images; a degradation module, configured to perform a degradation process on the first generated image to obtain a first degraded image of the first generated image; and a training module, configured to train the implicit vector and the generative network according to the first degraded image and a second degraded image of at least one target image, wherein a trained generative network and a trained implicit vector are used to generate at least one reconstructed image of the target image.

In a possible implementation, the training module includes: a feature acquisition submodule configured to input the first degraded image and the second degraded image of the target image respectively into a pre-trained discriminative network for processing to obtain a first discriminative feature of the first degraded image and a second discriminative feature of the second degraded image; and a first training submodule configured to train the implicit vector and the generative network according to the first discriminative feature and the second discriminative feature.

In a possible implementation, the discriminative network includes multiple levels of discriminative network blocks, and the feature acquisition submodule includes: a first acquisition submodule configured to input the first degraded image into the discriminative network for processing to obtain a plurality of first discriminative features outputted by the multiple levels of discriminative network blocks of the discriminative network; and a second acquisition submodule configured to input the second degraded image into the discriminative network for processing to obtain a plurality of second discriminative features outputted by the multiple levels of discriminative network blocks of the discriminative network.

In a possible implementation, the first training submodule includes: a loss determination submodule configured to determine a network loss of the generative network according to a distance between the first discriminative feature and the second discriminative feature; and a second training submodule configured to train the implicit vector and the generative network according to the network loss of the generative network.

In a possible implementation, the generative network includes N levels of generative network blocks, and the second training submodule is configured to: train first n levels of generative network blocks of the generative network according to the network loss of the generative network after an (n−1)th round of training to obtain the generative network after an nth round of training, where 1≤n≤N and n and N are integers.

In a possible implementation, the apparatus further comprises: a second generative module configured to input a plurality of initial implicit vectors into the pre-trained generative network to obtain a plurality of second generated images; a first vector determination module configured to determine the implicit vector from the plurality of initial implicit vectors according to information on difference between the target image and the plurality of second generated images.

In a possible implementation, the apparatus further comprises a second vector determination module configured to input the target image into a pre-trained coding network to output the implicit vector.

In a possible implementation, the apparatus further comprises: a first reconstruction module configured to input the trained implicit vector into the trained generative network to obtain the reconstructed image of the target image, wherein the reconstructed image includes a color image, and the second degraded image of the target image includes a gray level image; or the reconstructed image includes a complete image, and the second degraded image includes a deficient image; or a resolution of the reconstructed image is greater than a resolution of the second degraded image.

In one aspect of the present disclosure, there is provided an image generation apparatus, comprising: a disturbance module configured to perform a disturbance process on a implicit vector by random jittering information to obtain a disturbed implicit vector; and a second reconstruction module configured to input a disturbed implicit vector into a generative network for processing to obtain a reconstructed image of a target image, wherein a position of an object in the reconstructed image being different from a position of the object in the target image, wherein the implicit vector and the generative network are obtained from training according to the above network training apparatus.

In one aspect of the present disclosure, there is provided an image generation apparatus, comprising: a third reconstruction module configured to input a implicit vector and a category feature of a preset category into a generative network for processing to obtain a reconstructed image of a target image, wherein the generative network including a conditional generative network, a category of an object in the reconstructed image including the preset category, and a category of the object in the target image being different from the preset category, wherein the implicit vector and the generative network are obtained from training according to the above network training apparatus.

In one aspect of the present disclosure, there is provided an image generation apparatus, comprising: an interpolation module, configured to perform an interpolation process respectively on a first implicit vector, a second implicit vector, parameters of a first generative network and parameters of a second generative network to obtain at least one interpolated implicit vector and parameters of at least one interpolated generative network, wherein the first generative network being configured to generate a first reconstructed image of a first target image according to the first implicit vector, and the second generative network being configured to generate a second reconstructed image of a second target image according to the second implicit vector; and a morphing image acquisition module configured to input each interpolated implicit vector respectively into a corresponding interpolation generative network to obtain at least one morphing image, wherein a posture of an object in the at least one morphing image being between a posture of the object in the first target image and a posture of the object in the second target image, wherein the first implicit vector, the first generative network, the second implicit vector and the second generative network are obtained from training according to the above network training apparatus.

In one aspect of the present disclosure, there is provided an electronic device, comprising: a processor; and a memory configured to store processor executable instructions, wherein the processor is configured to invoke the instructions stored in the memory to execute the above method.

In one aspect of the present disclosure, a non-transitory computer readable storage medium having computer program instructions stored thereon, wherein the computer program instructions, when executed by a processor, implement the above method.

In one aspect of the present disclosure, there is provided a computer program, comprising computer readable codes, wherein when the computer readable codes run in an electronic device, a processor in the electronic device executes the above image processing method.

In embodiments of the present disclosure, a generated image can be obtained by a pre-trained generative network. An implicit vector and the generative network are trained simultaneously according to a difference between a degraded image of the generated image and a degraded image of an original image, thereby improving the training effect on the generative network, and achieving an image reconstruction with higher precision.

It should be understood that the above general descriptions and the following detailed descriptions are only exemplary and illustrative, and do not limit the present disclosure. Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 illustrates a flow chart of a network training method according to an embodiment of the present disclosure.

FIG. 2 illustrates a schematic diagram of a training process of a generative network according to an embodiment of the present disclosure.

FIG. 3 illustrates a block diagram of a network training apparatus according to an embodiment of the present disclosure.

FIG. 4 illustrates a block diagram of an electronic device according to an embodiment of the present disclosure.

FIG. 5 illustrates a block diagram of an electronic device according to an embodiment of the present disclosure.

### DETAILED DESCRIPTION

Various exemplary embodiments, features and aspects of the present disclosure are described in detail below with reference to the accompanying drawings. Numerical references in the drawings refer to elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

Terms “and/or” used herein is only an association relationship describing the associated objects, which means that there may be three relationships, for example, A and/or B may mean three situations: A exists alone, both A and B exist, and B exists alone. Furthermore, the item “at least one of” herein means any one of a plurality of or any combinations of at least two of a plurality of, for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure can be implemented without certain specific details. In some examples, methods, means, elements and circuits that are well known to those skilled in the art are not described in detail in order to highlight the main idea of the present disclosure.

In image restoration and image edition applications or software, it is usually necessary to reconstruct a target image so as to achieve image restoration and/or image manipulation tasks such as colorization, inpainting, super-resolution, adversarial defense, image morphing, and the likes. While the image being reconstructed, a generative network in a Generative Adversarial Networks (GAN), which has learned in a large number of natural images, may be used as a general image prior. An implicit vector and generator parameters are optimized simultaneously to perform the image reconstruction for improving the precision of the image reconstruction, so that information other than a target image may be restored, or a manipulation on senior semantic of the image may be implemented.

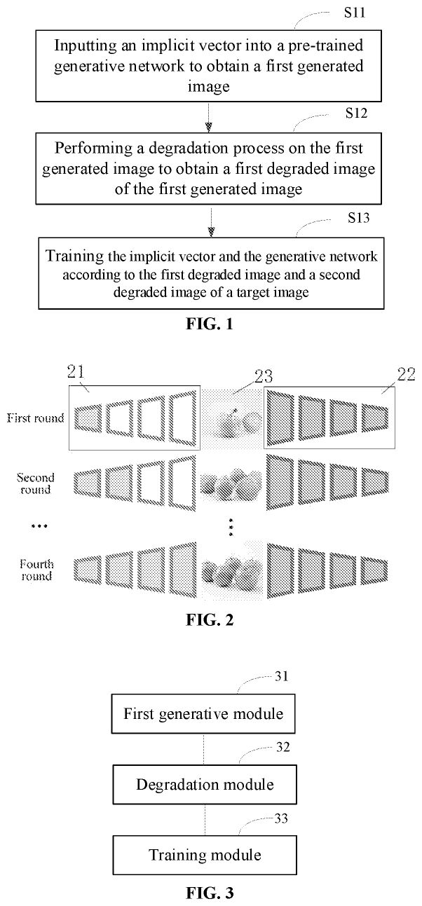

FIG. 1 illustrates a flow chart of a network training method according to an embodiment of the present disclosure. As shown in FIG. 1, the network training method includes:

at step S11, an implicit vector is inputted into a pre-trained generative network to obtain a first generated image, wherein the generative network is obtained with a discriminative network through adversarial trainings with a plurality of natural images;

at step S12, a degradation process is performed on the first generated image to obtain a first degraded image of the first generated image; and

at step S13, the implicit vector and the generative network are trained according to the first degraded image and a second degraded image of a target image, wherein the trained generative network and the trained implicit vector are used to generate a reconstructed image of the target image.

In a possible implementation, the network training method may be executed by an electronic device such as a terminal device or a server. The terminal device may be a user equipment (UE), a mobile device, a user terminal, a terminal, a cellular phone, or a cordless telephone, a personal digital assistant (PDA), a handheld device, a computing device, a vehicle-mounted device, a wearable device, etc. The method may be implemented by a processor invoking computer readable instructions stored in a memory; or the method may be executed by the server.

In relevant technologies, the generative adversarial network is a widely-used generative model, which includes a generative network G (Generator) and a discriminative network D (Discriminator). The generative network G is in charge of mapping the implicit vector to the generated image. The discriminative network D is in charge of distinguishing the generated image from a real image. The implicit vector may be, for example, obtained by sampling from a multivariate Gaussian distribution. The generative network G and the discriminative network D are trained in an adversarial learning method. After the training, a synthesized image may be obtained by sampling with the generative network G.

In a possible implementation, the generative network and the discriminative network can be trained in an adversarial manner through a plurality of natural images. The natural images may be images that objectively reflect natural scenes. A large number of natural images are used as samples, enabling the generative network and the discriminative network to learn more generic image prior information. After the adversarial training, the pre-trained generative network and discriminative network may be obtained. The present disclosure does not limit the selection of the natural images and a specific means of training for the adversarial training.

In an image reconstruction task, it is assumed that x is an original natural image (which may be referred to as the target image). \hat{x} is an image with partial information missing (for example, loss of color, loss of image blocks, loss of resolution, etc., and this type of images are referred to as degraded images below). According to the type of the missing information, \hat{x} may be regarded as being obtained by performing a degradation process on the target image (that is, obtained through \hat{x}=ϕ(x)). ϕ is a corresponding degradation transformation (for example, ϕ may be a graying transformation, which makes a color image into a gray level image). In this circumstance, the image reconstruction may be performed on the degraded image \hat{x} in a degradation space by the generative network.

It should be noted that in practical applications, usually there is only the degraded image \hat{x} but no original target image x, such as black-and-white photos obtained by early black-and-white cameras, or low-resolution photos obtained by low-resolution cameras. Therefore, “performing the degradation process on the target image” may be regarded as an assumed step, or an inevitable step due to the limitation of external factors/devices.

In a possible implementation, at step S11, the implicit vector may be inputted into the pre-trained generative network to obtain the first generated image. The implicit vector may be, for example, a randomly-initialized implicit vector, which is not limited in the present disclosure.

In a possible implementation, at step S12, the degradation processing may be performed on the first generated image to obtain the first degraded image of the first generated image. The means of degradation process is the same as the means for degrading the target image, for example, a graying process.

In a possible implementation, at step S13, the implicit vector and the generative network may be trained according to the difference (such as similarity or distance) between the first degraded image of the first generated image and the second degraded image of the target image. A training object for the generative network may be expressed as:

$${θ}^{*} , {z}^{*} = {argmin}_{θ , z} L ( \hat{x} , ϕ ( G ( z , θ ) ) ) \\ {x}^{*} = G ( {z}^{*} , {θ}^{*} ) \qquad ( 1 )$$

In the formula (1), θ may represent parameters of the generative network G; z may represent the implicit vector to be trained; G(z,θ) represents the first generated image; ϕ(G(z,θ)) represents the degraded image of the first generated image (may be referred to as the first degraded image); \hat{x} represents the degraded image of the target image (may be referred to as the second degraded image); and L represents a similarity measure between the first degraded image and the second degraded image. z* may represent the trained implicit vector; θ* may represent parameters of the trained generative network; and x* may represent a reconstructed image of the target image.

During the training, a network loss may be determined according to the similarity between the first degraded image and the second degraded image. The implicit vector and the parameters of the generative network are optimized by multiple iterations according to the network loss so that the network loss is converged; and the trained implicit vector and the trained generative network are obtained. The trained implicit vector and the trained generative network are used to generate the reconstructed image of the target image and to restore image information in the target image. Since the generative network G learns the distributions of the natural images, the reconstructed x* may restore the natural image information missing in \hat{x}. For example, if \hat{x} is a gray level image, x* is a corresponding color image.

In a possible implementation, during the training, parameter adjustments can be applied on the implicit vector and the parameters of the generative network through a back propagation algorithm and an Adaptive Moment Estimation (ADAM) optimization algorithm. The present disclosure does not limit a specific means of training.

According to an embodiment of the present disclosure, the generated image can be obtained through the pre-trained generative network. The implicit vector and the generative network are trained simultaneously according to the difference between the degraded image of the generated image and the degraded image of the original image, thereby improving the training effect on the generative network, and achieving an image reconstruction with higher precision.

In a possible implementation, prior to step S11, the implicit vector to be trained may be determined first. The implicit vector may be, for example, obtained directly by random sampling from a multivariate Gaussian distribution, or may be obtained by other means.

In a possible implementation, the method further includes: inputting a plurality of initial implicit vectors into the pre-trained generative network to obtain a plurality of second generated images; and determining the implicit vector from the plurality of initial implicit vectors according to information on difference between the target image and the plurality of second generated images.

For example, a plurality of initial implicit vectors may be obtained by random sampling, and each initial implicit vector can be inputted respectively into the pre-trained generative network G to obtain a plurality of second generated images. Further, the information on difference between the original target image and each second generated images may be obtained; for example, similarities (such as distances L1) between the target image and each second generated image are calculated, to determine the second generated image with the minimal difference (i.e., the maximal similarity); and the initial implicit vector corresponding to that second generated image may be determined as the implicit vector to be trained. In this way, the determined implicit vector could be close to the image information of the target image, thereby improving the training efficiency.

In a possible implementation, the method further includes: inputting the target image into a pre-trained coding network to output the implicit vector.

For example, the coding network (such as a convolutional neural network) may be preset, to encode the target image into the implicit vector. The coding network may be pre-trained through a sample image to obtain the pre-trained coding network. For example, the sample image is inputted into the coding network to obtain the implicit vector, and then the implicit vector is inputted into the pre-trained generative network to obtain the generated image;

and the coding network is trained according to the difference between the generated image and the sample image. The present disclosure does not limit a specific manner of training.

After the pre-training, the target image may be inputted into the pre-trained coding network, and the implicit vector to be trained will be outputted. In this way, the determined implicit vector may be closer to the image information of the target image, thereby improving the training efficiency.

In a possible implementation, step S13 may include:

inputting the first degraded image and the second degraded image of the target image respectively into the pre-trained discriminative network for processing, to obtain a first discriminative feature of the first degraded image and a second discriminative feature of the second degraded image;

training the implicit vector and the generative network according to the first discriminative feature and the second discriminative feature.

For example, in order to ensure that the reconstructed image is not distorted, the generative network may be trained according to a discriminative network corresponding to the generative network. The first degraded image and the second degraded image of the target image may be inputted respectively into the pre-trained discriminative network for processing, and the first discriminative feature of the first degraded image and the second discriminative feature of the second degraded image are outputted. The implicit vector and the generative network are trained according to the first discriminative feature and the second discriminative feature. For example, a network loss of the generative network is determined as a distance L1 between the first discriminative feature and the second discriminative feature, and then the the implicit vector and the parameters of the generative network are adjusted according to the network loss. In this way, the authenticity of the reconstructed image may be better retained.

In a possible implementation, the discriminative network further includes multiple levels of discriminative network blocks.

Inputting the first degraded image and the second degraded image of the target image respectively into the pre-trained discriminative network for processing to obtain the first discriminative feature of the first degraded image and the second discriminative feature of the second degraded image includes:

inputting the first degraded image into the discriminative network for processing to obtain a plurality of first discriminative features outputted by multiple levels of discriminative network blocks of the discriminative network;

inputting the second degraded image into the discriminative network for processing to obtain a plurality of second discriminative features outputted by the multiple levels of discriminative network blocks of the discriminative network.

For example, the discriminative network may include multiple levels of discriminative network blocks. Each discriminative network block may be, for example, a residual block. Each residual block, for example, includes at least one residual layer, a fully-connected layer and a pooling layer. The present disclosure does not limit a specific structure for each discriminative network block.

In a possible implementation, the first degraded image may be inputted into the discriminative network for processing, obtaining the first discriminative features outputted by various levels of discriminative network blocks. Similarly, the second degraded image is inputted into the discriminative network for processing, obtaining the second discriminative features outputted by various levels of discriminative network blocks. In this way, features of different depths of the discriminative network may be obtained, so that the subsequent similarity measures will be more accurate.

In a possible implementation, the step of training the implicit vector and the generative network according to the first discriminative feature and the second discriminative feature may include:

determining the network loss of the generative network according to the distance between the first discriminative feature and the second discriminative feature; and training the implicit vector and the generative network according to the network loss of the generative network.

For example, the distance L1 between a plurality of first discriminative features and a plurality of second discriminative features may be determined:

$$L ( {x}_{1} , {x}_{2} ) = {\sum }_{i ∈ I} ‖ D ( {x}_{1} , i ) , D ( {x}_{2} , i ) ‖ \qquad ( 2 )$$

In the formula (2), x₁ may represent the first degraded image; x₂ may represent the second degraded image; and D(x₁,i) and D(x₂,i) may represent respectively the first discriminative feature and the second discriminative feature outputted by an i^{th} level of discriminative network blocks, where I represents the number of levels of the discriminative network blocks, 1≤i≤I, and i and I is an integer.

In a possible implementation, the distance L1 may be used directly as the network loss of the generative network. The distance L1 may also be combined with other loss functions to jointly serve as the network loss of the generative network. The generative network is then trained according to the network loss. The present disclosure does not limit the selection and combination manners for the loss functions.

Compared with other similarity measures, this method can better retain the authenticity of reconstructed pictures, improving the training effect on the generative network.

In a possible implementation, the generative network includes N levels of generative network blocks.

The step of training the implicit vector and the generative network according to the network loss of the generative network includes:

training first n levels of generative network blocks of the generative network according to the network loss of the generative network after an (n−1)^{t} round of training, to obtain the generative network after an n^{th} round of training, where 1≤n≤N, and n and N are integers.

For example, the generative network may include N levels of generative network blocks. Each level of generative network block may, for example, includes at least one convolutional layer. The present disclosure does not limit a specific structure for each level of generative network block.

In a possible implementation, the network training may be performed with a progressive parameter optimization method. The training process is divided into N rounds. For any round (set as the n^{th} round) in the N rounds of training, the first n levels of generative network blocks of the generative network are trained according to the network loss of the generative network after the (n−1)^{th} round of training, to obtain the generative network after the n^{th} round of training. When n=1, the generative network after the (n−1)^{th} round of training is the pre-trained generative network.

That is, the first level of generative network block of the generative network may be trained according to the network loss of the pre-trained network to obtain the generative network after the first round of training; the first and the second levels of generative network blocks of the generative network are trained according to the network loss of the generative network after the first round of training to obtain the generative network after the second round of training; and the rest can be done in the same manner, the first to the N^{th} levels of generative network blocks of the generative network are trained according to the network loss of the generative network after the (N−1)^{th} round of training to obtain the generative network after the N^{th} round of training, which is used as the final generative network.

FIG. 2 illustrates a schematic diagram of a training process of a generative network according to an embodiment of the present disclosure. As shown in FIG. 2, a generative network 21 may, for example, include 4 levels of generative network blocks. A discriminative network 22 may, for example, include 4 levels of discriminative network blocks. An implicit vector (not shown) is inputted into the generative network 21 to obtain a generated image 23. The generated image 23 is inputted into the discriminative network 22 to obtain output features of the 4 levels of discriminative network blocks of the discriminative network 22. Output features of the 4 levels of discriminative network blocks function as the network loss of the generative network 21. The training process of the generative network 21 may be divided into four rounds. The first level of generative network block is trained at the first round; the first and the second levels of generative network blocks are trained at the second round; . . . ; and the first to the fourth levels of generative network blocks are trained at the fourth round, obtaining the trained generative network.

A better optimization effect may be obtained by optimizing a shallow layer first and then progressively optimizing deep layers, thereby improving the performance of the generative network.

In a possible implementation, the method further includes:

inputting the trained implicit vector into the trained generative network to obtain a reconstructed image of the target image, wherein the reconstructed image includes a color image; and a second degraded image of the target image includes a gray level image; or

the reconstructed image includes a complete image, and the second degraded image includes a deficient image; or

a resolution of the reconstructed image is greater than a resolution of the second degraded image.

For example, after the training process of the implicit vector and the generative network is finished in the step S13, the trained implicit vector and generative network may be obtained. Further, an image restoration task may be done through the trained implicit vector and generative network. That is, the trained implicit vector is inputted into the trained generative network to obtain the reconstructed image of the target image. The present disclosure does not limit a task type included in the image restoration task.

When the image restoration task is a colorization task, the second degraded image of the target image is a gray level image (a corresponding degradation function includes graying), and the reconstructed image generated by the generative network is a color image.

When the image restoration task is an image inpainting task, the second degraded image of the target image is a deficient image, that is, the second degraded image has a missing part, and the corresponding degradation function is expressed as ϕ(x)=x⊙m, where m represents a binary mask corresponding to the image inpainting task, ⊙ represents a dot product, and the reconstructed image generated by the generative network is a complete image.

When the image restoration task is a super-resolution task, the second degraded image of the target image is a blurred image (the corresponding degradation function includes downsampling), and the reconstructed image generated by the generative network is a clear image; that is, the resolution of the reconstructed image is greater than the resolution of the second degraded image.

In this way, the generative network can restore information that is not contained in the target image, improving significantly the restoration effect of the image restoration task.

In a possible implementation, an image manipulation task (may also be referred to as an image edition task) may also be implemented through the trained implicit vector and generative network. The present disclosure does not limit the task type included in the image manipulation task. processing procedures of several image manipulation tasks are described below.

According to an embodiment of the present disclosure, there is also provided an image generation method. The method includes:

performing a disturbance process on a first implicit vector by random jittering information to obtain a disturbed first implicit vector;

inputting the disturbed first implicit vector into a first generative network for processing to obtain a reconstructed image of a target image, a position of an object in the reconstructed image is different from a position of the object in the target image,

wherein the first implicit vector and the first generative network are obtained from training according to the above network training method.

For example, the trained implicit vector and generative network (which are referred to as the first implicit vector and the first generative network here) may be obtained from training according to the above network training method. The random jittering is realized through the first implicit vector and the first generative network. The random jittering information may be set. The random jittering information may be, for example, a random vector or a random number, which is not limited in the present disclosure.

In a possible implementation, the disturbance process may be performed on the first implicit vector by the random jittering information. For example, the random jittering information is superimposed with the first implicit vector to obtain the disturbed first implicit vector. The disturbed first implicit vector is then inputted into the first generative network for processing to obtain the reconstructed image of the target image. The position of the object in the reconstructed image is different from the position of the object in the target image, thereby realising the random jittering of the object in the image. In this way, the processing effect of the image manipulation task may be improved.

According to an embodiment of the present disclosure, there is also provided an image generation method. The method includes:

inputting a second implicit vector and a category feature of a preset category into a second generative network for processing to obtain a reconstructed image of a target image. The second generative network includes a conditional generative network. The category of the object in the reconstructed image includes the preset category. The category of the object in the target image is different from the preset category. The second implicit vector and the second generative network are obtained from training according to the above network training method.

For example, the trained implicit vector and generative network (which are referred to as the second implicit vector and the second generative network here) may be obtained from training according to the above network training method. The category transfer of the object is implemented through the second implicit vector and the second generative network. The second generative network may be a generative network in a conditional GAN, and the input thereof includes the implicit vector and the category feature.

In a possible implementation, a plurality of categories may be preset. Each preset category has a corresponding category feature. The second implicit vector and the category feature of the preset category are inputted into the second generative network for processing, which may obtain the reconstructed image of the target image. The category of the object in the reconstructed image is the preset category. The category of the object in the original target image is different from the preset category. For example, when the object is an animal, the animal in the target image is a dog, and the animal in the reconstructed image is a cat. When the object is a vehicle, the vehicle in the target image is a bus, and the vehicle in the reconstructed image is a truck.

In this way, the category transfer of the object in the image may be realized, thereby improving the processing effect of the image manipulation task.

According to an embodiment of the present disclosure, there is also provided an image generation method. The method includes:

performing an interpolation process respectively on a third implicit vector, a fourth implicit vector, parameters of a third generative network and parameters of a fourth generative network, to obtain at least one interpolated implicit vector and parameters of at least one interpolated generative network. The third generative network is configured to generate a reconstructed image of a first target image according to the third implicit vector. The fourth generative network is configured to generate a reconstructed image of a second target image according to the fourth implicit vector;

inputting each interpolated implicit vector respectively into the corresponding interpolated generative network to obtain at least one morphing image. A posture of an object in the at least one morphing image is between a posture of the object in the first target image and a posture of the object in the second target image,

wherein the third implicit vector, the third generative network, the fourth implicit vector and the fourth generative network are obtained from training according to the above network training method.

For example, two or more implicit vectors and generative networks may be obtained from training according to the above network training method. The consecutive transition, i.e., image morphing, between two images may be implemented through these implicit vectors and generative networks.

In a possible implementation, the third implicit vector, the third generative network, the fourth implicit vector and the fourth generative network may be obtained from training.

The third generative network is configured to generate the reconstructed image of the first target image according to the third implicit vector, and the fourth generative network is configured to generate the reconstructed image of the second target image according to the fourth implicit vector.

In a possible implementation, the interpolation process may be performed respectively on the third implicit vector, the fourth implicit vector, the parameters of the third generative network and the parameters of the fourth generative network, to obtain at least one interpolated implicit vector and parameters of at least one interpolated generative network; that is, corresponding multiple groups of interpolated implicit vectors and interpolated generative networks may be obtained. The present disclosure does not limit a specific manner for interpolation.

In a possible implementation, each interpolation implicit vector may be inputted respectively into the corresponding interpolated generative network to obtain at least one morphing image. The posture of the object in the at least one morphing image is between the posture of the object in the first target image and the posture of the object in the second target image. Thus, one or more obtained morphing images may realize the transition between two images.

In a case where many morphing images are obtained, the reconstructed image of the first target image, a plurality of morphing images and the reconstructed image of the second target image may also be used as video frames to form a section of video, thereby completing the transfer from the discrete images to the consecutive video.

In this way, the transition between the images may be implemented, thereby improving the processing effect of the image manipulation task.

The method according to the embodiment of the present disclosure utilizes the generative network in the Generative Adversarial Networks (GAN) learned in a large number of natural images as the universal image prior, and optimizes the implicit vector and the generator parameters simultaneously for image reconstruction, which can restore the information other than the target image, for example, restoring the color of a gray level image. The manifold of the image can be learned, thereby realizing the manipulation for senior semantic of the image.

Furthermore, the method according to the embodiment of the present disclosure adopts the distance L1 of the features of the discriminative network in the generative adversarial networks as the similarity measure for the image reconstruction, and the optimization on parameters of the generative network may be performed in a progressive manner, so that the network training effect may be further improved, and the image reconstruction with higher precision can be realized.

The method according to the embodiment of the present disclosure can be applied to image restoration and image edition applications or software, effectively realizing the reconstructions of various target images, and may realize a series of image restoration tasks and image manipulation tasks, including but not limited to: colorization, inpainting, super-resolution, adversarial defense, random jittering, image morphing, category transfer, etc. The user may utilize the present method to restore the color of a gray level picture, to change a low-resolution image to a high-resolution image, and to restore a missing image block of a picture; the content of the picture can also be manipulated, for example, changing a dog in a picture to a cat, changing the posture of the dog in the picture, realizing a consecutive transition of two pictures, and the likes.

It may be understood that the above method embodiments described in the present disclosure may be combined with each other to form combined embodiments without departing from principles and logics, which are not repeated in the present disclosure due to space limitation. It will be appreciated by those skilled in the art that a specific execution sequence of various steps in the above method in the specific implementations should be determined on the basis of their functions and possible intrinsic logics. It should be understood that the terms “first”, “second”, “third” and “fourth” in the claims, specification and accompanying drawings of the present disclosure are used to distinguish different objects, rather than describing a specific order.

Furthermore, the present disclosure further provides a network training apparatus, an image generation apparatus, an electronic device, a computer readable storage medium and a program, all of which may be used to implement any network training method and image generation method provided in the present disclosure. For the corresponding technical solutions and descriptions, please refer to the respective statements in the method part, which will not be repeated here.

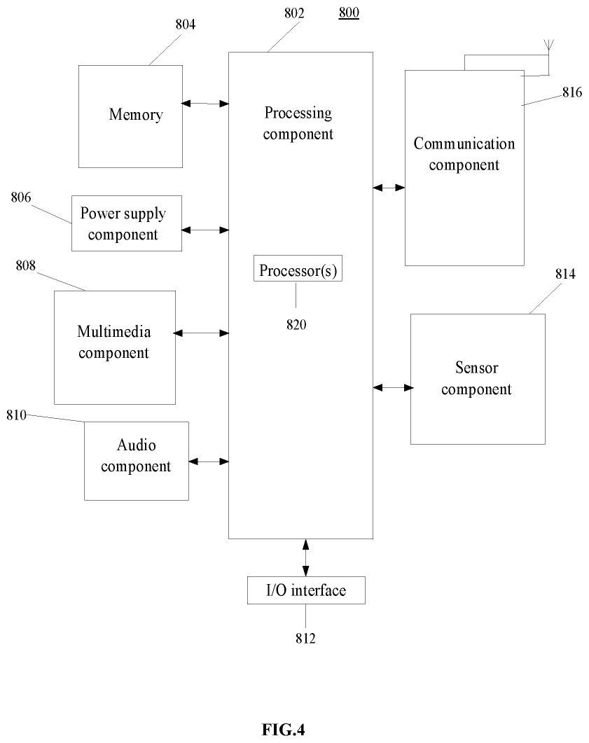

FIG. 3 illustrates a block diagram of a network training apparatus according to an embodiment of the present disclosure. As shown in FIG. 3, the apparatus includes:

a first generative module 31, configured to input an implicit vector to a pre-trained generative network to obtain a first generated image, wherein the generative network is obtained with a discriminative network through adversarial trainings with a plurality of natural image;

a degradation module 32, configured to perform a degradation process on the first generated image to obtain a first degraded image of the first generated image; and

a training module 33, configured to train the implicit vector and the generative network according to the first degraded image and a second degraded image of a target image, wherein the trained generative network and the trained implicit vector are used to generate a reconstructed image of the target image.

In a possible implementation, the training module includes: a feature acquisition submodule configured to input the first degraded image and the second degraded image of the target image respectively into a pre-trained discriminative network for processing to obtain a first discriminative feature of the first degraded image and a second discriminative feature of the second degraded image; and a first training submodule configured to train the implicit vector and the generative network according to the first discriminative feature and the second discriminative feature.

In a possible implementation, the discriminative network includes multiple levels of discriminative network blocks. The feature acquisition submodule includes: a first acquisition submodule configured to input the first degraded image into the discriminative network for processing to obtain a plurality of first discriminative features outputted by the multiple levels of discriminative network blocks of the discriminative network; and a second acquisition submodule configured to input the second degraded image into the discriminative network for processing to obtain a plurality of second discriminative features outputted by the multiple levels of discriminative network blocks of the discriminative network.

In a possible implementation, the first training submodule includes: a loss determination submodule for determining a network loss of the generative network according to a distance between the first discriminative feature and the second discriminative feature; and a second training submodule for training the implicit vector and the generative network according to the network loss of the generative network.

In a possible implementation, the generative network includes N levels of generative network blocks. The second training submodule is configured to train first n levels of generative network blocks of the generative network according to the network loss of the generative network after an (n−1)^{th} round of training, to obtain the generative network after an n^{th} round of training, where 1≤n≤N, and n and N are integers.

In a possible implementation, the apparatus further includes: a second generative module for inputting a plurality of initial implicit vectors into the pre-trained generative network to obtain a plurality of second generated images; and a first vector determination module for determining the implicit vector from the plurality of initial implicit vectors according to information on difference between the target image and the plurality of second generated images.

In a possible implementation, the apparatus further includes: a second vector determination module for inputting the target image into a pre-trained coding network to output the implicit vector.

In a possible implementation, the apparatus further includes: a first reconstruction module for inputting the trained implicit vector into the trained generative network to obtain a reconstructed image of the target image, wherein the reconstructed image includes a color image, and the second degraded image of the target image includes a gray level image; or the reconstructed image includes a complete image, and the second degraded image includes a deficient image; or the resolution of the reconstructed image is greater than the resolution of the second degraded image.

According to an aspect of the present disclosure, there is provided an image generation apparatus including: a disturbance module for performing a disturbance process on a first implicit vector by random jittering information to obtain a disturbed first implicit vector; and a second reconstruction module for inputting the disturbed first implicit vector into the first generative network for processing to obtain a reconstructed image of the target image, wherein a position of an object in the reconstructed image is different from a position of the object in the target image, and the first implicit vector and the first generative network are obtained from training according to the above network training apparatus.

According to an aspect of the present disclosure, there is provided an image generation apparatus including: a third reconstruction module for inputting a second implicit vector and a category feature of a preset category respectively into a second generative network for processing to obtain a reconstructed image of the target image. The second generative network includes a conditional generative network. The category of the object in the reconstructed image includes the preset category. The category of the object in the target image is different from the preset category. The second implicit vector and the second generative network are obtained from training according to the above network training apparatus.

According to an aspect of the present disclosure, there is provided an image generation apparatus including: an interpolation module for performing an interpolation process respectively on a third implicit vector, a fourth implicit vector, parameters of a third generative network and parameters of a fourth generative network to obtain at least one interpolated vector and parameters of at least one interpolated generative network, the third generative network is configured to generate the reconstructed image of the first target image according to the third implicit vector, and the fourth generative network is configured to generate the reconstructed image of the second target image according to the fourth implicit vector; and a morphing image acquisition module for inputting each interpolated implicit vector respectively into the corresponding interpolated generative network to obtain at least one morphing image, wherein a posture of an object in the at least one morphing image is between a posture of the object in the first target image and a posture of the object in the second target image. The third implicit vector, the third generative network, the fourth implicit vector and the fourth generative network are obtained from training according to the network training apparatus of any one of claims 12-18.

In some embodiments, functions or modules of the apparatus provided in the embodiments of the present disclosure may be used to execute the method described in the above method embodiments, which may be specifically implemented by referring to the above descriptions of the method embodiments, and are not repeated here for brevity.

An embodiment of the present disclosure further provides a computer readable storage medium having computer program instructions stored thereon, wherein the computer program instructions, when executed by a processor, implement the above method. The computer readable storage medium may be a non-volatile computer readable storage medium or volatile computer readable storage medium.

An embodiment of the present disclosure further provides an electronic device, which includes a processor and a memory configured to store processor executable instructions, wherein the processor is configured to invoke the instructions stored in the memory to execute the above method.

An embodiment of the present disclosure further provides a computer program product, which includes computer readable codes. When the computer readable code is run on the device, the processor in the device executes the instructions for implementing the network training method and the image generation method as provided in any of the above embodiments.

An embodiment of the present disclosure further provides another computer program product, which is configured to store computer readable instructions. The instructions are executed to cause the computer to perform operation of the network training method and the image generation method provided in any one of the above embodiments.

The electronic device may be provided as a terminal, a server or a device in any other form.

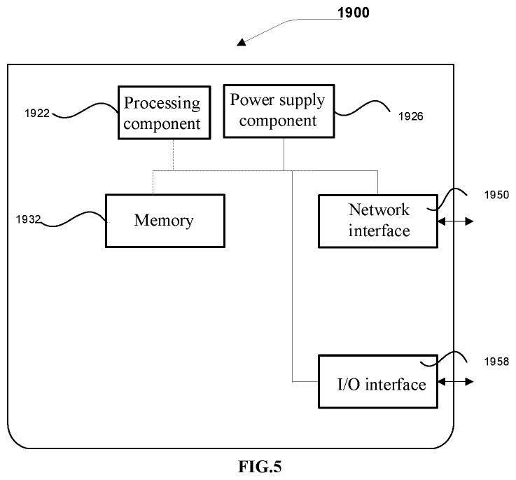

FIG. 4 illustrates a block diagram of an electronic device 800 according to an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 4, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above methods. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), programmable read-only memory (PROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera.

When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative locations of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or

CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultra-wide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above methods.

In an exemplary embodiment, there is further provided a non-volatile computer readable storage medium, such as a memory 804 including computer program instructions. The computer program instructions may be executed by a processor 820 of an electronic device 800 to implement the above methods.

FIG. 5 illustrates a block diagram of an electronic device 1900 according to an embodiment of the present disclosure. For example, the electronic device 1900 may be provided as a server. Referring to FIG. 5, the electronic device 1900 includes a processing component 1922, which further includes one or more processors and memory resources represented by a memory 1932 and configured to store instructions executed by the processing component 1922, such as an application program. The application program stored in the memory 1932 may include one or more modules each corresponding to a group of instructions.

Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions.

The computer program instructions may be executed by a processing module 1922 of an electronic device 1900 to execute the above methods.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

Without violating logic, different embodiments of the present disclosure can be combined with each other, and the descriptions of different embodiments are emphasized. The emphasized part of the description can be found in descriptions of other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A network training method, comprising:
inputting at least one implicit vector into at least one pre-trained generative network to obtain a first generated image, wherein the generative network being obtained with a discriminative network through adversarial trainings with a plurality of natural images;
performing a degradation process on the first generated image to obtain a first degraded image of the first generated image; and
training the implicit vector and the generative network according to the first degraded image and a second degraded image of at least one target image, wherein a trained generative network and a trained implicit vector are used to generate at least one reconstructed image of the target image.

2. The method according to claim 1, wherein training the implicit vector and the generative network according to the first degraded image and the second degraded image of the at least one target image includes:
inputting the first degraded image and the second degraded image of the target image respectively into a pre-trained discriminative network for processing, to obtain a first discriminative feature of the first degraded image and a second discriminative feature of the second degraded image; and
training the implicit vector and the generative network according to the first discriminative feature and the second discriminative feature.

3. The method according to claim 2, wherein the discriminative network includes multiple levels of discriminative network blocks, and
inputting the first degraded image and the second degraded image of the target image respectively into the pre-trained discriminative network for processing to obtain the first discriminative feature of the first degraded image and the second discriminative feature of the second degraded image includes:
inputting the first degraded image into the discriminative network for processing to obtain a plurality of first discriminative features outputted by the multiple levels of discriminative network blocks of the discriminative network; and
inputting the second degraded image into the discriminative network for processing to obtain a plurality of second discriminative features outputted by the multiple levels of discriminative network blocks of the discriminative network.

4. The method according to claim 2, wherein training the implicit vector and the generative network according to the first discriminative feature and the second discriminative feature includes:
determining a network loss of the generative network according to a distance between the first discriminative feature and the second discriminative feature; and
training the implicit vector and the generative network according to the network loss of the generative network.

5. The method according to claim 4, wherein the generative network includes N levels of generative network blocks, and
training the implicit vector and the generative network according to the network loss of the generative network includes:
training first n levels of generative network blocks of the generative network according to the network loss of the generative network after an (n−1)^{th} round of training, to obtain the generative network after an n^{th} round of training, where 1≤n≤N, and n and N are integers.

6. The method according to claim 1, wherein the method further comprises:
inputting a plurality of initial implicit vectors into the pre-trained generative network to obtain a plurality of second generated images; and
determining the implicit vector from the plurality of initial implicit vectors according to information on difference between the target image and the plurality of second generated images.

7. The method according to claim 1, wherein the method further comprises:
inputting the target image into a pre-trained coding network to output the implicit vector.

8. The method according to claim 1, wherein the method further comprises:
inputting the trained implicit vector into the trained generative network to obtain the reconstructed image of the target image,
wherein the reconstructed image includes a color image, and the second degraded image of the target image includes a gray level image; or
the reconstructed image includes a complete image, and the second degraded image includes a deficient image; or
a resolution of the reconstructed image is greater than a resolution of the second degraded image.

9. The method according to claim 1, wherein the method further comprising:
performing a disturbance process on the implicit vector by random jittering information to obtain a disturbed implicit vector; and
inputting the disturbed implicit vector into the generative network for processing to obtain the reconstructed image of the target image, wherein a position of an object in the reconstructed image being different from a position of the object in the target image.

10. The method according to claim 1, wherein the method further comprising:
inputting the implicit vector and a category feature of a preset category into the generative network for processing to obtain the reconstructed image of the target image, wherein the generative network including a conditional generative network, a category of an object in the reconstructed image including the preset category, and a category of the object in the target image being different from the preset category.

11. The method according to claim 1, wherein,
the at least one implicit vector comprises a first implicit vector and a second implicit vector, the at least one generative network comprises a first generative network and a second generative network, the at least one target image comprises a first target image and a second target image, and the at least one reconstructed image comprises a first reconstructed image and a second reconstructed image;
the method further comprising:
performing an interpolation process respectively on the first implicit vector, the second implicit vector, parameters of the first generative network and parameters of the second generative network, to obtain at least one interpolated implicit vector and parameters of at least one interpolated generative network, wherein the first generative network being configured to generate the first reconstructed image of the first target image according to the first implicit vector, the second generative network being configured to generate the second reconstructed image of the second target image according to the second implicit vector; and
inputting each interpolated implicit vector respectively into a corresponding interpolated generative network to obtain at least one morphing image, wherein a posture of an object in the at least one morphing image being between a posture of the object in the first target image and a posture of the object in the second target image.

12. An electronic device, comprising:
at least one processor; and
a memory configured to store processor executable instructions,
wherein the at least one processor is configured to invoke the instructions stored in the memory to:
input at least one implicit vector into at least one pre-trained generative network to obtain a first generated image, wherein the generative network being obtained with a discriminative network through adversarial trainings with a plurality of natural images;
perform a degradation process on the first generated image to obtain a first degraded image of the first generated image; and
train the implicit vector and the generative network according to the first degraded image and a second degraded image of at least one target image, wherein a trained generative network and a trained implicit vector are used to generate at least one reconstructed image of the target image.

13. The electronic device according to claim 12, wherein the at least one processor is configured to invoke the instructions stored in the memory to:
input the first degraded image and the second degraded image of the target image respectively into a pre-trained discriminative network for processing to obtain a first discriminative feature of the first degraded image and a second discriminative feature of the second degraded image; and
train the implicit vector and the generative network according to the first discriminative feature and the second discriminative feature.

14. The electronic device according to claim 13, wherein the discriminative network includes multiple levels of discriminative network blocks, and the at least one processor is configured to invoke the instructions stored in the memory to:
input the first degraded image into the discriminative network for processing to obtain a plurality of first discriminative features outputted by the multiple levels of discriminative network blocks of the discriminative network; and
input the second degraded image into the discriminative network for processing to obtain a plurality of second discriminative features outputted by the multiple levels of discriminative network blocks of the discriminative network.

15. The electronic device according to claim 13, wherein the at least one processor is configured to invoke the instructions stored in the memory to:
determine a network loss of the generative network according to a distance between the first discriminative feature and the second discriminative feature; and
train the implicit vector and the generative network according to the network loss of the generative network.

16. The electronic device according to claim 15, wherein the generative network includes N levels of generative network blocks, and the at least one processor is configured to invoke the instructions stored in the memory to:
train first n levels of generative network blocks of the generative network according to the network loss of the generative network after an (n−1)^{th} round of training to obtain the generative network after an n^{th} round of training, where 1≤n≤N, and n and N are integers.

17. The electronic device according to claim 12, wherein the at least one processor is configured to invoke the instructions stored in the memory to:
perform a disturbance process on the implicit vector by random jittering information to obtain a disturbed implicit vector; and
input the disturbed implicit vector into the generative network for processing to obtain the reconstructed image of the target image, wherein a position of an object in the reconstructed image being different from a position of the object in the target image.

18. The electronic device according to claim 12, wherein the at least one processor is configured to invoke the instructions stored in the memory to:
input the implicit vector and a category feature of a preset category into the generative network for processing to obtain the reconstructed image of the target image, wherein the generative network including a conditional generative network, a category of an object in the reconstructed image including the preset category, and a category of the object in the target image being different from the preset category.

19. The electronic device according to claim 12, wherein,
the at least one implicit vector comprises a first implicit vector and a second implicit vector, the at least one generative network comprises a first generative network and a second generative network, the at least one target image comprises a first target image and a second target image, and the at least one reconstructed image comprises a first reconstructed image and a second reconstructed image;
the at least one processor is configured to invoke the instructions stored in the memory to
perform an interpolation process respectively on the first implicit vector, the second implicit vector, parameters of the first generative network and parameters of the second generative network, to obtain at least one interpolated implicit vector and parameters of at least one interpolated generative network, wherein the first generative network being configured to generate the first reconstructed image of the first target image according to the first implicit vector, the second generative network being configured to generate the second reconstructed image of the second target image according to the second implicit vector; and
a morphing image acquisition module configured to input each interpolated implicit vector respectively into a corresponding interpolation generative network to obtain at least one morphing image, wherein a posture of an object in the at least one morphing image being between a posture of the object in the first target image and a posture of the object in the second target image.

20. A non-transitory computer readable storage medium having computer program instructions stored thereon, wherein the computer program instructions, when executed by a processor, cause the processor to:
input at least one implicit vector into at least one pre-trained generative network to obtain a first generated image, wherein the generative network being obtained with a discriminative network through adversarial trainings with a plurality of natural images;
perform a degradation process on the first generated image to obtain a first degraded image of the first generated image; and
train the implicit vector and the generative network according to the first degraded image and a second degraded image of at least one target image, wherein a trained generative network and a trained implicit vector are used to generate at least one reconstructed image of the target image.
